(19) United States
(12) Patent Application Publication
(10) Pub. No.: US 2021/0398527 A1
(43) Pub. Date: Dec. 23, 2021

(54) TERMINAL SCREEN PROJECTION CONTROL METHOD AND TERMINAL

(71) Applicant: HUAWEI TECHNOLOGIES CO., LTD., SHENZHEN, GUANGDONG (CN)

(72) Inventor: Shaohua XIA, Shenzhen (CN)

(21) Appl. No.: 17/285,563

(22) PCT Filed: Oct. 14, 2019
(86) PCT No.: PCT/CN2019/110926

§ 371 Date: Apr. 15, 2021

(30) Foreign Application Priority Data
Oct. 16, 2018 (CN) 201811204521.3

(51) Int. Cl. G10L 15/22; G10L 15/18

(52) U.S. Cl. CPC G10L 15/22; G10L 15/1815; G10L 2015/225; G10L 2015/223; G10L 15/1822

(57) ABSTRACT

Embodiments of this application disclose a terminal screen projection control method and a terminal, to improve application processing efficiency in a scenario in which a terminal is connected to a large screen. The embodiments of this application provide a terminal screen projection control method. The method is applied to a terminal. The terminal is connected to a display device. The method includes: The terminal collects first voice data; the terminal performs voice recognition processing on the first voice data; and the terminal controls, based on a result of the voice recognition processing, the display device to display content associated with the first voice data.

This application is a national stage of International Application No. PCT/CN2019/110926, filed on Oct. 14, 2019, which claims priority to Chinese Patent Application No. 201811204521.3, filed on Oct. 16, 2018. Both of the aforementioned applications are hereby incorporated by reference in their entireties. their entireties.

### TECHNICAL FIELD

This application relates to the field of communications technologies, and in particular, to a terminal screen projection control method and a terminal.

### BACKGROUND

Currently, mobile terminals have been widely used. A user often encounters some scenarios, for example, wanting to share content such as a photo, a video, or a document in a mobile terminal with a friend around the user. In the prior art, a common manner is to open a small screen of a mobile terminal to share with another user. From a perspective of user experience, the “small screen” of the mobile terminal is absolutely unsatisfactory.

In the prior art, a mobile terminal screen projection manner is used. To be specific, a mobile terminal is connected to a large screen, a user may operate an application of the mobile terminal, and operation content of the user is displayed by connecting the mobile terminal to the large screen, thereby implementing content sharing based on the large screen.

In the prior art, the user needs to hold the terminal or connect an external mouse and keyboard to the terminal to control the application. In the prior art, the user needs to manually control the terminal to display the application on the large screen. As a result, two hands of the user cannot be released, and application processing efficiency in a scenario in which the terminal is connected to the large screen is reduced.

### SUMMARY

Embodiments of this application provide a terminal screen projection control method and a terminal, to improve application processing efficiency in a scenario in which a terminal is connected to a large screen.

To resolve the foregoing problem, the embodiments of this application provide the following technical solutions:

According to a first aspect, an embodiment of this application provides a terminal screen projection control method. The method is applied to a terminal. The terminal is connected to a display device. The method includes: The terminal collects first voice data. The terminal performs voice recognition processing on the first voice data. The terminal controls, based on a result of the voice recognition processing, the display device to display content associated with the first voice data.

In this embodiment of this application, the terminal is connected to the display device. The terminal collects the first voice data, and then the terminal performs the voice recognition processing on the first voice data to generate the result of the voice recognition processing. Next, the terminal controls an application of the terminal based on the result of the voice recognition processing. Finally, the terminal displays a control process of the application on the display device. In this embodiment of this application, a user may directly deliver a voice command to the terminal in a voice communication manner. The terminal may collect the first voice data sent by the user. The terminal may control the application based on the result of the voice recognition processing. In this way, in an execution process of the application, the control process can be displayed on the display device connected to the terminal device, and the user does not need to manually operate the terminal, thereby improving application processing efficiency in a scenario in which the terminal is connected to a large screen.

In an embodiment, that the terminal controls, based on a result of the voice recognition processing, a display device to display content associated with the first voice data includes: The terminal recognizes an application programming interface corresponding to the result of the voice recognition processing. The terminal controls an application by using the application programming interface, and displays related content on the display device. The terminal recognizes, based on the result of the voice recognition processing, an application that needs to be controlled by a user. For example, the terminal recognizes the application programming interface corresponding to the result of the voice recognition processing. Different application programming interfaces are configured for different application programs. After recognizing the application programming interface, the terminal can determine, by using the application programming interface, the application that needs to be controlled by the user.

In an embodiment, that the terminal recognizes an application programming interface corresponding to the result of the voice recognition processing includes: The terminal performs semantic analysis on the result of the voice recognition processing, to generate a semantic analysis result. The terminal extracts an instruction from the semantic analysis result. The terminal recognizes the application programming interface according to the instruction. The result of the voice recognition processing that is generated by the terminal may be text information. The terminal performs semantic analysis on the text information to generate a semantic analysis result, and the terminal extracts an instruction from the semantic analysis result. For example, the terminal generates the instruction based on a preset instruction format. Finally, the terminal recognizes the application programming interface according to the extracted instruction. In this embodiment of this application, a semantic analysis function may be configured in the terminal. To be specific, the terminal may learn and understand semantic content represented by a segment of text, and finally convert the semantic content into a command and a parameter that can be recognized by a machine.

In an embodiment, that the terminal recognizes an application programming interface corresponding to the result of the voice recognition processing includes: The terminal sends the result of the voice recognition processing to a cloud server, so that the cloud server performs semantic analysis on the result of the voice recognition processing. The terminal receives an analysis result fed back by the cloud server after the semantic analysis. The terminal recognizes the application programming interface based on the analysis result. The result of the voice recognition processing that is generated by the terminal may be text information. The terminal establishes a communication connection to the cloud server. For example, the terminal may send the text information to the cloud server, so that the cloud server performs semantic analysis on the text information. After completing the semantic analysis, the cloud server generates an instruction, and sends the instruction. The terminal may receive an analysis result fed back by the cloud server after the semantic analysis. Finally, the terminal recognizes the application programming interface according to the extracted instruction.

In an embodiment, after the terminal controls, based on the result of the voice recognition processing, the display device to display the content associated with the first voice data, the method further includes: The terminal obtains a feedback result of the application. The terminal converts the feedback result into second voice data, and plays the second voice data. Alternatively, the terminal displays the feedback result on the display device. When the terminal executes the application, the application may further generate the feedback result. The feedback result may indicate that the application successfully responds to the voice command of the user, or may indicate that the application fails to respond to the voice command. After obtaining the feedback result, the terminal may convert the feedback result into the second voice data, and play the second voice data. For example, a player is configured in the terminal, and the terminal may play the second voice data by using the player, so that the user can hear the second voice data. In addition to playing, by using voice, the second voice data corresponding to the feedback result, the terminal may further display the feedback result on the display device, so that the user can determine, on the display device connected to the terminal, whether execution of the voice command succeeds or fails.

In an embodiment, that the terminal collects first voice data includes: The terminal invokes a voice assistant in a wake-up-word-free manner, so that the voice assistant performs voice collection on the first voice data. The voice assistant may be configured in the terminal, and voice collection may be performed by using the voice assistant. To improve voice collection efficiency, the terminal may invoke the voice assistant in the wake-up-word-free manner. The wake-up-word-free is relative to the voice assistant, and there is no need to first start the voice assistant application. The user may directly say a sentence to the terminal, and the terminal may automatically invoke the voice assistant and execute a voice command.

According to a second aspect, an embodiment of this application provides a terminal. The terminal is connected to a display device. The terminal includes a voice collector and a processor. The processor and the voice collector communicate with each other. The voice collector is configured to collect first voice data. The processor is configured to: perform voice recognition processing on the first voice data; and control, based on a result of the voice recognition processing, the display device to display content associated with the first voice data.

In an embodiment, the processor is further configured to: recognize an application programming interface corresponding to the result of the voice recognition processing; and control the application by using the application programming interface, and display related content on the display device.

In an embodiment, the processor is further configured to: call a management service function module by using the application programming interface; and control the application by using the management service function module.

In an embodiment, the processor is further configured to: perform semantic analysis on the result of the voice recognition processing, to generate a semantic analysis result; extract an instruction from the semantic analysis result; and recognize the application programming interface according to the instruction.

In an embodiment, the processor is further configured to: send the result of the voice recognition processing to a cloud server, so that the cloud server performs semantic analysis on the result of the voice recognition processing; receive an analysis result fed back by the cloud server after the semantic analysis; and recognize the application programming interface based on the analysis result.

In an embodiment, the terminal further includes a player. The player is connected to the processor. The processor is further configured to: obtain a feedback result of the application after controlling, based on the result of the voice recognition processing, the display device to display the content associated with the first voice data; and convert the feedback result into second voice data, and control the player to play the second voice data; or control the display device to display the feedback result.

In an embodiment, the processor is further configured to invoke a voice assistant in a wake-up-word-free manner. The voice collector is configured to perform voice collection on the first voice data under control of the voice assistant.

In the second aspect of this application, composition modules of the terminal may further perform the operations described in the first aspect and the possible implementations. For details, refer to the descriptions in the first aspect and the possible implementations.

According to a third aspect, an embodiment of this application further provides a terminal. The terminal is connected to a display device. The terminal includes:

a collection module, configured to collect first voice data; a voice recognition module, configured to perform voice recognition processing on the first voice data; and a display module, configured to control, based on a result of the voice recognition processing, a display device to display content associated with the first voice data.

In an embodiment, the display module includes: an interface recognition unit, configured to recognize an application programming interface corresponding to the result of the voice recognition processing; and a control unit, configured to: control an application by using the application programming interface, and display related content on the display device.

In an embodiment, the interface recognition unit is configured to: perform semantic analysis on the result of the voice recognition processing, to generate a semantic analysis result; extract an instruction from the semantic analysis result; and recognize the application programming interface according to the instruction.

In an embodiment, the interface recognition unit is configured to: send the result of the voice recognition processing to a cloud server, so that the cloud server performs semantic analysis on the result of the voice recognition processing; receive an analysis result fed back by the cloud server after the semantic analysis; and recognize the application programming interface based on the analysis result.

In an embodiment, the terminal further includes an obtaining module and a play module. The obtaining module is configured to obtain a feedback result of the application after the display module controls, based on the result of the voice recognition processing, the display device to display the content associated with the first voice data. The play module is configured to: convert the feedback result into second voice data, and play the second voice data. Alternatively, the display module is further configured to display the feedback result on the display device.

In an embodiment, the collection module is further configured to invoke a voice assistant in a wake-up-word-free manner, so that the voice assistant performs voice collection on the first voice data.

According to a third aspect, an embodiment of this application provides a computer readable storage medium. The computer readable storage medium stores an instruction. When the instruction is run on a computer, the computer is enabled to perform the method according to the first aspect.

According to a fourth aspect, an embodiment of this application provides a computer program product including an instruction. When the computer program product is run on a computer, the computer is enabled to perform the method according to the first aspect.

According to a fifth aspect, an embodiment of this application provides a communications apparatus. The communications apparatus may include an entity such as a terminal or a chip. The communications apparatus includes a processor and a memory. The memory is configured to store an instruction. The processor is configured to execute the instruction in the memory, so that the communications apparatus performs the method according to any one of the first aspect or the possible implementations of the first aspect.

According to a sixth aspect, this application provides a chip system. The chip system includes a processor, configured to support a terminal in implementing functions in the foregoing aspects, for example, sending or processing data and/or information in the foregoing methods. In a possible embodiment, the chip system further includes a memory. The memory is configured to store a program instruction and data that are necessary for the terminal. The chip system may include a chip, or may include a chip and another discrete device.

### BRIEF DESCRIPTION OF DRAWINGS

FIG. 1 is a schematic structural composition diagram of a communications system to which a terminal screen projection control method is applied according to an embodiment of this application;

FIG. 2 is a schematic block flowchart of a terminal screen projection control method according to an embodiment of this application;

FIG. 3 is a schematic diagram of an implementation architecture for performing terminal screen projection control on a document application according to an embodiment of this application;

FIG. 4 is a schematic flowchart of performing voice control on a document application according to an embodiment of this application;

FIG. 5 is a schematic structural composition diagram of a terminal according to an embodiment of this application;

FIG. 6-a is a schematic structural composition diagram of another terminal according to an embodiment of this application;

FIG. 6-b is a schematic structural composition diagram of a display module according to an embodiment of this application;

FIG. 6-c is a schematic structural composition diagram of another terminal according to an embodiment of this application; and

FIG. 7 is a schematic structural composition diagram of another terminal according to an embodiment of this application.

### DESCRIPTION OF EMBODIMENTS

Embodiments of this application provide a terminal screen projection control method and a terminal, to improve application processing efficiency in a scenario in which a terminal is connected to a large screen.

The following describes the embodiments of this application with reference to accompanying drawings.

In the specification, claims, and accompanying drawings of this application, the terms “first”, “second”, and so on are intended to distinguish between similar objects but do not necessarily indicate a specific order or sequence. It should be understood that the terms used in such a way are interchangeable in proper circumstances, which is merely a discrimination manner that is used when objects having a same attribute are described in the embodiments of this application. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, system, product, or device.

The technical solutions in the embodiments of this application may be applied to various data processing communications systems. As shown in FIG. 1, the communications system includes a terminal. The terminal is connected to a display device. The display device may be a large screen used for display. The terminal may be connected to the display device in a wired or wireless manner. For example, the terminal is connected to the display device by using a high definition multimedia interface (HDMI), or the terminal is connected to the display device by using a Type-C interface. The terminal is also referred to as user equipment (UE), a mobile station (MS), a mobile terminal (MT), or the like, and is a device that provides voice and/or data connectivity for a user, or a chip disposed in the device, for example, a hand-held device or a vehicle-mounted device that have a wireless connection function. Currently, examples of some terminals are: a mobile phone, a tablet computer, a notebook computer, a palmtop computer, a mobile interne device (MID), a wearable device, a virtual reality (viVR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, and a wireless terminal in a mart home. The terminal provided in the embodiments of this application only needs to be connected to one display device, to perform the terminal screen projection control method provided in the embodiments of this application.

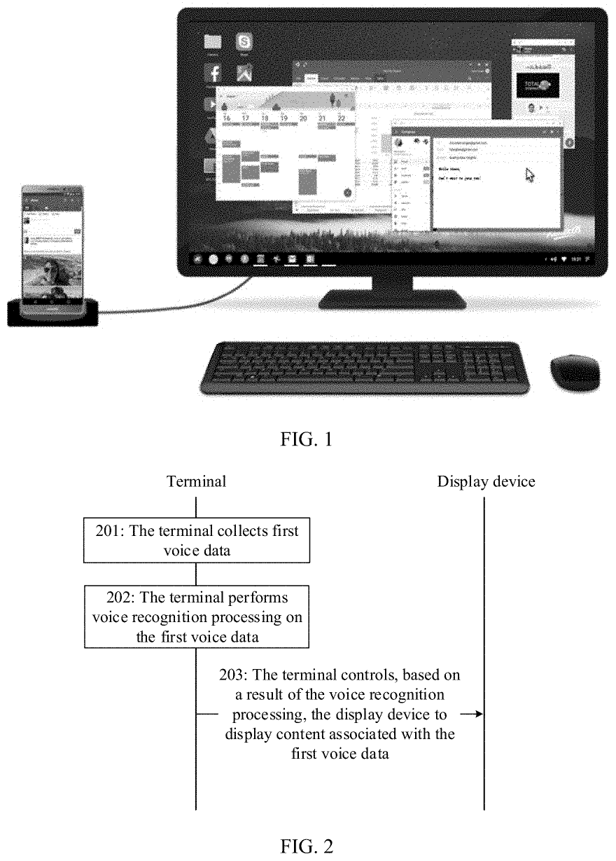

An embodiment of this application provides a terminal screen projection control method. The method is applied to a terminal. The terminal is connected to a display device. Referring to FIG. 2, the terminal screen projection control method provided in this embodiment of this application mainly includes the following operations.

Operation 201: The terminal collects first voice data.

In this embodiment of this application, a user may operate an application by using the terminal. A type of the application is not limited. For example, the application may be a document application, a game application, or an audio/video application. The application is displayed on the display device connected to the terminal. When the user needs to operate the application, a voice control manner is used. To be specific, the user sends a voice command. The terminal is equipped with a built-in voice collector, and the terminal collects, by using the voice collector, the voice command sent by the user. For example, the terminal collects the first voice data within a period of time. In a subsequent embodiment, a terminal screen projection control process of the first voice data is used as an example for description. Terminal screen projection control may alternatively be performed, based on a processing process of the first voice data, on other voice data collected by the terminal. This is merely described herein.

In some embodiments of this application, operation 201 of collecting first voice data by the terminal includes:

The terminal invokes a voice assistant in a wake-up-word-free manner, and the voice assistant performs voice collection on the first voice data.

The voice assistant may be configured in the terminal, and voice collection may be performed by using the voice assistant. To improve voice collection efficiency, the terminal may invoke the voice assistant in the wake-up-word-free manner. The wake-up-word-free is relative to the voice assistant, and there is no need to first start the voice assistant application. The user may directly say a sentence to the terminal, and the terminal may automatically invoke the voice assistant and execute the voice command.

Operation 202: The terminal performs voice recognition processing on the first voice data.

In an embodiment of this application, after the terminal collects the first voice data, the terminal performs voice recognition processing on the first voice data, to recognize text information corresponding to the first voice data. A result of the voice recognition processing that is generated by the terminal may include the text information.

In an embodiment of this application, the terminal may perform voice recognition processing on the first voice data by using a natural-language understanding (natural-language understanding, NLU) tool. Voice recognition is a process in which a machine converts the first voice data into corresponding text information through a recognition and understanding process. The result of the voice recognition processing that is generated by the terminal may be used to control the application of the terminal.

Operation 203: The terminal controls, based on the result of the voice recognition processing, the display device to display content associated with the first voice data.

In this embodiment of this application, after the terminal performs voice recognition processing on the first voice data, the terminal may control the application by using the result of the voice recognition processing. The terminal may directly use the result of the voice recognition processing as a command to control the application. The terminal may alternatively obtain an instruction corresponding to the result of the voice recognition processing, and control the application according to the instruction. A manner of controlling the application depends on the result of the voice recognition processing that is generated by the terminal. For example, the application is a document application. If the user sends a voice command for opening a document A, the terminal may control the document application to open the document A.

In some embodiments of this application, operation 203 of controlling, by the terminal based on the result of the voice recognition processing, the display device to display content associated with the first voice data includes:

The terminal recognizes an application programming interface corresponding to the result of the voice recognition processing.

The terminal controls the application by using the application programming interface, and displays related content on the display device.

The terminal recognizes, based on the result of the voice recognition processing, the application that needs to be controlled by the user. For example, the terminal recognizes the application programming interface corresponding to the result of the voice recognition processing, and different application programming interfaces are configured for different application programs. After the terminal recognizes the application programming interface, the terminal may determine, by using the application programming interface, the application that needs to be controlled by the user. In an actual application, a management service function module may be disposed in the terminal, and the application is controlled by using the management service function module. For example, the management service function module may be specifically a personal computer (personal computer, PC) management service module. The application programming interface is recognized by using the PC management service module. The application programs that need to be controlled by the user is controlled by using the application programming interface.

Further, in some embodiments of this application, that the terminal recognizes the application programming interface corresponding to the result of the voice recognition processing includes:

The terminal performs semantic analysis on the result of the voice recognition processing, to generate a semantic analysis result.

The terminal extracts an instruction from the semantic analysis result.

The terminal recognizes the application programming interface according to the instruction.

The result of the voice recognition processing that is generated by the terminal may be text information. The terminal performs semantic analysis on the text information to generate the semantic analysis result, and the terminal extracts the instruction from the semantic analysis result. For example, the terminal generates the instruction based on a preset instruction format. Finally, the terminal recognizes the application programming interface according to the extracted instruction. In this embodiment of this application, a semantic analysis function may be configured in the terminal. To be specific, the terminal may learn and understand semantic content represented by a segment of text, and finally convert the semantic content into a command and a parameter that can be recognized by a machine.

In some other embodiments of this application, that the terminal recognizes the application programming interface corresponding to the result of the voice recognition processing includes:

The terminal sends the result of the voice recognition processing to a cloud server. The cloud server performs semantic analysis on the result of the voice recognition processing.

The terminal receives an analysis result fed back by the cloud server after the semantic analysis.

The terminal recognizes the application programming interface based on the analysis result.

The result of the voice recognition processing that is generated by the terminal may be text information. The terminal establishes a communication connection to the cloud server. For example, the terminal may send the text information to the cloud server, so that the cloud server performs semantic analysis on the text information. After completing the semantic analysis, the cloud server generates an instruction, and sends the instruction. The terminal may receive an analysis result fed back by the cloud server after the semantic analysis. Finally, the terminal recognizes the application programming interface according to the extracted instruction.

In this embodiment of this application, the display device is controlled, based on the result of the voice recognition processing, to display the content associated with the first voice data. When the terminal controls the application, the terminal generates the content associated with the first voice data, and displays, based on the related content, a control process of the application on the display device connected to the terminal. The user delivers the voice command of the application by using voice. Therefore, the user does not need to hold the terminal to perform a touch operation, and does not need to operate the application by using a mouse or a keyboard, thereby improving application processing efficiency in a scenario in which the terminal is connected to a large screen.

In some embodiments of this application, after operation 203 of controlling, by the terminal based on the result of the voice recognition processing, the display device to display the content associated with the first voice data, in addition to the foregoing operations, the terminal may further perform the following operations in the terminal screen projection control method provided in this embodiment of this application:

The terminal obtains a feedback result of the application.

The terminal converts the feedback result into second voice data, and plays the second voice data.

Alternatively, the terminal displays the feedback result on the display device.

When the terminal executes the application, the application may further generate a feedback result. The feedback result may indicate that the application successfully responds to the voice command of the user, or may indicate that the application fails to respond to the voice command. For example, the application is a document application. If the user sends a voice command for opening a document A, the terminal may control the document application to open the document A. The document application may generate a feedback result based on an execution status of the document A. The feedback result may be that the document A is opened successfully or fails to be opened. After obtaining the feedback result, the terminal may convert the feedback result into the second voice data, and play the second voice data. For example, a player is configured in the terminal, and the terminal may play the second voice data by using the player, so that the user can hear the second voice data. In addition to playing, by using voice, the second voice data corresponding to the feedback result, the terminal may further display the feedback result on the display device, so that the user can determine, on the display device connected to the terminal, whether execution of the voice command succeeds or fails.

In some embodiments of this application, the application may further generate a feedback result only when the execution fails, and prompt the user that the execution fails. The application may not generate a feedback result when the execution succeeds, thereby reducing disturbance from the terminal to the user.

It can be learned from the example description of this application in the foregoing embodiment that the terminal is connected to the display device. The terminal collects the first voice data, and then the terminal performs the voice recognition processing on the first voice data to generate the result of the voice recognition processing. Next, the terminal controls the application of the terminal based on the result of the voice recognition processing. Finally, the terminal displays the control process of the application on the display device. In this embodiment of this application, the user may directly deliver the voice command to the terminal in a voice communication manner. The terminal may collect the first voice data sent by the user. The terminal may control the application based on the result of the voice recognition processing. In this way, in an execution process of the application, the control process can be displayed on the display device connected to the terminal device, and the user does not need to manually operate the terminal, thereby improving application processing efficiency in a scenario in which the terminal is connected to a large screen.

To help better understand and implement the foregoing solutions of the embodiments of this application, corresponding application scenarios are specifically described by way of example below.

In the terminal screen projection control method provided in the embodiments of this application, the terminal is connected to a large screen (which is referred to as a large screen for short). The terminal first performs voice recognition. After the user sends an instruction, the terminal converts collected voice of the user into text, and then the terminal sends the text to the cloud server. The cloud server performs semantic analysis, that is, the cloud server analyzes the recognized text, and converts the text into an instruction and a parameter that can be recognized by a machine. The terminal finally executes the command. That is, the terminal can execute various recognized commands on the large screen based on the instruction and the parameter. Executing various commands on the large screen means that the user feels that the application is operated on the large screen. However, in actual execution, the application still runs on the terminal, and only a control process of the terminal is projected onto the large screen. In addition, what is displayed on the large screen is different from what is displayed on the terminal. In other words, the terminal executes a different-source mode.

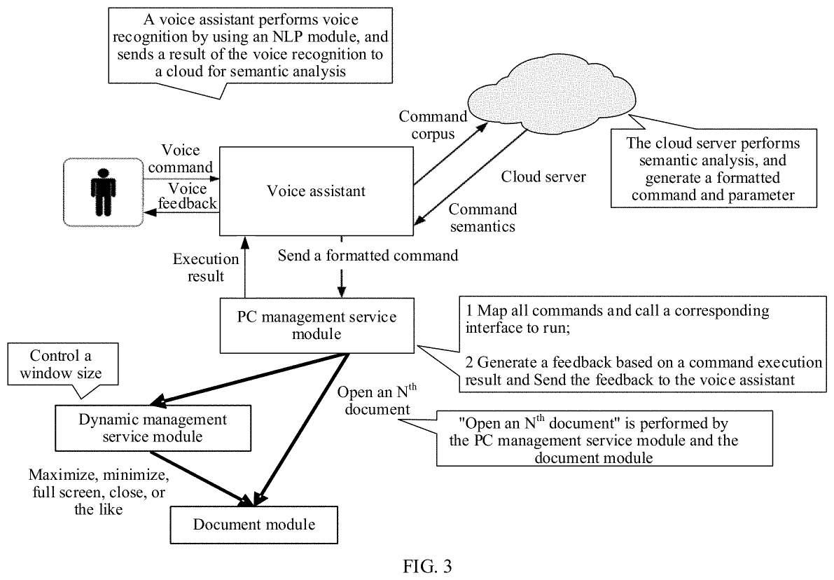

FIG. 3 is a schematic diagram of an implementation architecture for performing terminal screen projection control on a document application according to an embodiment of this application. For example, an application is a document application, and a terminal is a mobile phone. The document application may be a WPS document, or may be a DOC document. In an actual application scenario, a lecturer explains a document (for example, a PPT) and uses a mobile phone to perform projection, and the mobile phone is in a different-source mode. If the lecturer is relatively far away from the mobile phone, an application on a large screen cannot be controlled by using a mouse click in the prior art. In this embodiment of this application, the lecturer may control the document application by using voice.

An operation procedure in this embodiment of this application is as follows:

Operation 1: The lecturer may send a pre-trained “wake-up-word-free” command to the mobile phone to invoke a voice assistant, for example, send voice “Xiaoyi Xiaoyi” to the mobile phone, to invoke the voice assistant to enter a listening state.

Operation 2: The lecturer says “Open WPS”.

The voice assistant performs recording, and the remaining process is executed by a voice control module. A function of the voice assistant is to convert collected user voice data into text.

For example, after receiving a command, the voice assistant sends recorded data to an NLU module, to recognize the voice and generate text information. Then, the voice assistant sends the text information to a semantic analysis module of a cloud server. For example, the voice assistant sends a command corpus to the cloud server, so that the cloud server analyzes text. After obtaining text through analysis, the cloud server generates an instruction and a parameter that can be recognized by the mobile phone, and sends command semantics to the voice assistant. Then, the voice assistant sends the command semantics to the mobile phone. The mobile phone executes the corresponding command, and the WPS is opened. The mobile phone is connected to a display or a television to display an operation process of a document application projected from the mobile phone. Next, the mobile phone sends a command feedback to the voice assistant. Finally, the voice assistant plays the feedback to the lecturer.

Next, the lecturer may continue to say the following commands and give a complete PPT explanation. For example, the lecturer may send the following voice commands: “Open the second document”, “Play”, “Next page”, “Previous page”, “Exit”, and “Close”. The lecturer may also say “maximize”, “minimize”, “full screen”, and the like to control a window of the WPS or another application.

The following describes a system architecture provided in the embodiments of this application. An Android system is used as an example. The system architecture consists of the following typical modules:

The voice assistant is first described. The voice assistant may receive a voice input of a user, then perform voice recognition by using an NLU to convert the voice input into text, and then send the text to a cloud server for semantic recognition. After being recognized by the cloud server, the voice input is sent to a PC management service module (for example, a PC service) of the mobile phone by using the voice assistant on the mobile phone for execution. The PC service is a newly added system service in the mobile phone, and is a server end for managing projection in a different-source mode on the mobile phone. The voice assistant can also play feedback of an execution result that is sent by the PC service.

The cloud server analyzes the text to form a command and a parameter that can be recognized by the PC service.

A window management system in the mobile phone controls a window size. For example, the window management system may include a dynamic management service module (ActivityManagerService), and may further include a window management service (WindowManagerService) module. For example, the dynamic management service module is used to control the window size, for example, maximizing, minimizing, full screen, or closing. The ActivityManagerService and WindowManagerService are Android applications and window management modules on the mobile phone. The PC service invokes application programming interfaces (application programming interface, API) of the two services to control a window.

The following describes an implementation process of a management service. The PC service, ActivityManagerService, and WindowManagerService are Android system services. The PC service can invoke the ActivityManagerService and WindowManagerService. The PC Service maps all commands and selects an interface of an appropriate object module to run. Feedback is generated based on a command execution result and is sent to the voice assistant. For example, if the ActivityManagerService and WindowManagerService can maximize and minimize the window, the PC service invokes the APIs of the ActivityManagerService and WindowManagerService. However, to open an Nth document in the WPS, the PC service needs to cooperate with a WPS module. The PC service sends a command to the WPS module, and then the WPS module executes the command and sends a notification of an execution result.

Finally, the application in the embodiments of this application is described. The application may be a document application (for example, a WPS application), a game application, an audio/video application, or the like.

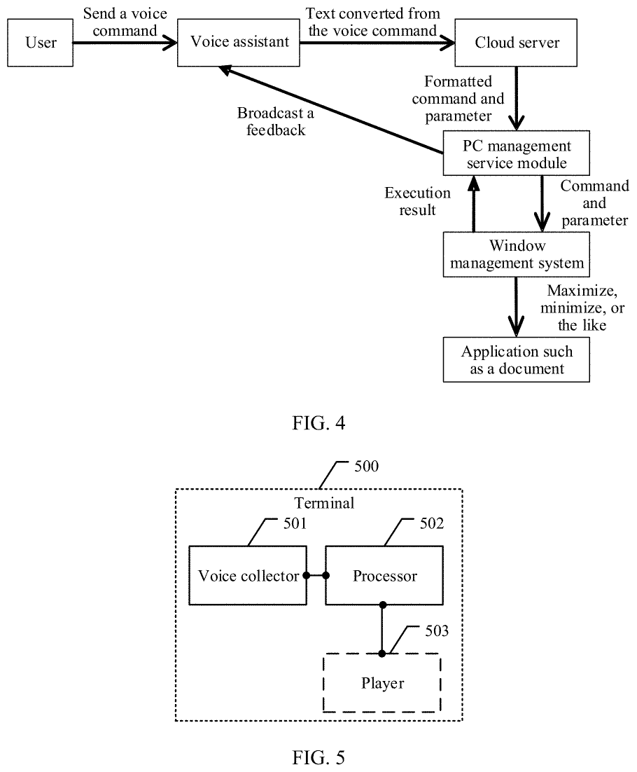

FIG. 4 is a schematic flowchart of performing voice control on a document application according to an embodiment of this application. After using a large screen for a period of time, a user may need to free both hands and expect to use a voice communication manner. In this embodiment of this application, the user may directly deliver a command to a mobile phone, the command is executed on the large screen, and appropriate feedback is made when necessary. For example, the user opens a PPT document for browsing, and then closes the PPT document after browsing. The user may send a series of commands to the mobile phone. A voice assistant in the mobile phone converts a voice command into text, and then sends the text to a cloud server. After performing semantic analysis, the cloud server generates a formatted command and parameter, and then sends the formatted command and parameter to a PC management service module of the mobile phone. Then, the PC management service module sends the command and parameter to a window management system of the mobile phone. The window management system performs control such as maximizing or minimizing on an application such as a document. The window management system may further generate an execution result and send the execution result to the PC management service module. The PC management service module sends the execution result to the voice assistant, and the voice assistant broadcasts feedback.

For example, the command may be used to open the voice assistant on the mobile phone.

The mobile phone opens the voice assistant in a wake-up-word-free manner, and automatically enters a listening state. For example, if the user needs to open an office application on the large screen, the user sends the following voice command: open WPS. In this case, the mobile phone opens WPS on the large screen and enters a document list. For example, if the user needs to open a PPT document in the document list, the user sends the following voice command: open the second document. In this case, the mobile phone opens the second PPT document in the document list. For example, if the user needs to play a PPT, the user sends the following voice command: play. In this case, the PPT on the large screen of the mobile phone enters a play state. For example, if the user needs to enter a next page, the user sends the following voice command: next page. In this case, the mobile phone turns the PPT to the next page. For example, if the user needs to replay a previous page, the user sends the following voice command: previous page. In this case, the mobile phone turns the PPT to the previous page. For example, if the user needs to end playing, the user sends the following voice command: exit. In this case, the mobile phone returns the PPT to an unplayed state. For example, if the user needs to close the PPT, the user sends the following voice command: close the WPS. In this case, the mobile phone closes the WPS application.

According to the terminal screen projection control method provided in the embodiments of this application, the large screen may be controlled by using voice for mobile office.

It should be noted that, for brief description, the foregoing method embodiments are represented as a series of actions. However, a person skilled in the art should appreciate that this application is not limited to the described order of the actions, because according to this application, some operations may be performed in other orders or simultaneously. It should be further appreciated by a person skilled in the art that the embodiments described in this specification all belong to example embodiments, and the involved actions and modules are not necessarily required by this application.

To help better implement the foregoing solutions of the embodiments of this application, the following further provides related apparatuses for implementing the foregoing solutions.

FIG. 5 is a schematic structural composition diagram of a terminal according to an embodiment of this application. The terminal is connected to a display device. The terminal 500 may include a voice collector 501 and a processor 502. The processor 502 and the voice collector 501 communicate with each other.

The voice collector 501 is configured to collect first voice data.

The processor 502 is configured to: perform voice recognition processing on the first voice data; and control, based on a result of the voice recognition processing, a display device to display content associated with the first voice data.

In some embodiments of this application, the processor 502 is further configured to: recognize an application programming interface corresponding to the result of the voice recognition processing; and control the application by using the application programming interface, and display related content on the display device.

In some embodiments of this application, the processor 502 is further configured to: call a management service function module by using the application programming interface; and control the application by using the management service function module.

In some embodiments of this application, the processor 502 is further configured to: perform semantic analysis on the result of the voice recognition processing, to generate a semantic analysis result; extract an instruction from the semantic analysis result; and recognize the application programming interface according to the instruction.

In some embodiments of this application, the processor 502 is further configured to: send the result of the voice recognition processing to a cloud server, so that the cloud server performs semantic analysis on the result of the voice recognition processing; receive an analysis result fed back by the cloud server after the semantic analysis; and recognize the application programming interface based on the analysis result.

In some embodiments of this application, as shown in FIG. 5, the terminal 500 further includes a player 503. The player 503 is connected to the processor 502.

The processor 502 is further configured to: obtain a feedback result of the application after the display device displays a control process of the application program; and convert the feedback result into second voice data, and control the player 503 to play the second voice data; or control the display device to display the feedback result.

In some embodiments of this application, the processor 502 is further configured to invoke a voice assistant in a wake-up-word-free manner.

The voice collector 501 is configured to perform voice collection on the first voice data under control of the voice assistant.

In this embodiment of this application, the terminal is connected to the display device. The terminal collects the first voice data, and then the terminal performs the voice recognition processing on the first voice data to generate the result of the voice recognition processing. Next, the terminal controls the application of the terminal based on the result of the voice recognition processing. Finally, the terminal displays the control process of the application on the display device. In this embodiment of this application, a user may directly deliver a voice command to the terminal in a voice communication manner. The terminal may collect the first voice data sent by the user. The terminal may control the application based on the result of the voice recognition processing. In this way, in an execution process of the application, the control process can be displayed on the display device connected to the terminal device, and the user does not need to manually operate the terminal, thereby improving application processing efficiency in a scenario in which the terminal is connected to a large screen.

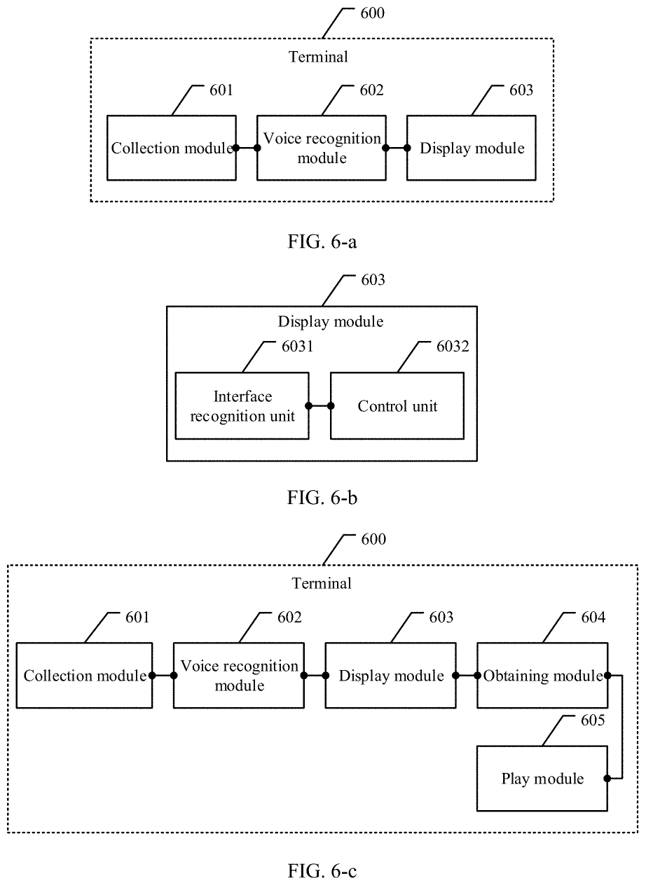

As shown in FIG. 6-a, an embodiment of this application further provides a terminal 600. The terminal 600 is connected to a display device. The terminal 600 includes:

a collection module 601, configured to collect first voice data;

a voice recognition module 602, configured to perform voice recognition processing on the first voice data; and

a display module 603, configured to control, based on a result of the voice recognition processing, the display device to display content associated with the first voice data.

In some embodiments of this application, as shown in FIG. 6-b, the display module 603 includes:

an interface recognition unit 6031, configured to recognize an application programming interface corresponding to the result of the voice recognition processing; and a control unit 6032, configured to: control the application by using the application programming interface, and display related content on the display device.

In some embodiments of this application, the interface recognition unit 6031 is configured to: perform semantic analysis on the result of the voice recognition processing, to generate a semantic analysis result; extract an instruction from the semantic analysis result; and recognize the application programming interface according to the instruction.

In some embodiments of this application, the interface recognition unit 6031 is configured to: send the result of the voice recognition processing to a cloud server, so that the cloud server performs semantic analysis on the result of the voice recognition processing; receive an analysis result fed back by the cloud server after the semantic analysis; and recognize the application programming interface based on the analysis result.

In some embodiments of this application, as shown in FIG. 6-c, the terminal 600 further includes an obtaining module 604 and a play module 605.

The obtaining module 604 is configured to obtain a feedback result of the application after the display module 603 displays a control process of the application on the display device.

The play module 605 is configured to: convert the feedback result into second voice data, and play the second voice data.

Alternatively, the display module 603 is further configured to display the feedback result on the display device.

It should be noted that content such as information exchange between the modules/units of the apparatus and the execution processes thereof is based on the same idea as the method embodiments of this application, and produces the same technical effects as the method embodiments of this application. For the specific content, refer to the foregoing description in the method embodiments of this application, and the details are not described herein again.

The embodiments of this application further provide a computer storage medium. The computer storage medium may store a program, and, when the program is executed, at least a part or all of the operations of any data resource registration method in the foregoing method embodiments may be performed.

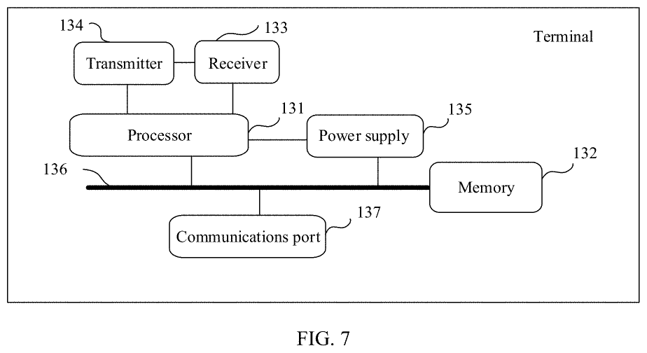

FIG. 7 is a schematic structural diagram of still another terminal according to an embodiment of this application. The terminal may include a processor 131 (for example, a CPU), a memory 132, a transmitter 134, and a receiver 133. The transmitter 134 and the receiver 133 are coupled to the processor 131. The processor 131 controls a sending action of the transmitter 134 and a receiving action of the receiver 133. The memory 132 may include a high-speed RAM memory, or may further include a non-volatile memory NVM, for example, at least one magnetic disk storage. The memory 132 may store various instructions, to complete various processing functions and implement method operations in the embodiments of this application. Optionally, the terminal in this embodiment of this application may further include one or more of a power supply 135, a communications bus 136, and a communications port 137. The receiver 133 and the transmitter 134 may be integrated into a transceiver of the terminal, or may be a receive antenna and a transmit antenna that are independent of each other on the terminal. The communications bus 136 is configured to implement a communication connection between components. The communications port 137 is configured to implement connection and communication between the terminal and another peripheral device.

In an embodiment of this application, the memory 132 is configured to store computer executable program code, and the program code includes an instruction. When the processor 131 executes the instruction, the instruction enables the processor 131 to perform a processing action of the terminal in the foregoing method embodiment, and enables the transmitter 134 to perform a sending action of the terminal in the foregoing method embodiment. Implementation principles and technical effects thereof are similar, and details are not described herein again.

In another possible embodiment, when the terminal is a chip, the chip includes a processing unit and a communications unit. The processing unit may be, for example, a processor. The communications unit may be, for example, an input/output interface, a pin, or a circuit. The processing unit may execute a computer executable instruction stored in a storage unit, so that a chip in the terminal performs any wireless communication method in the first aspect. Optionally, the storage unit is a storage unit in the chip, such as a register or a cache. Alternatively, the storage unit may be a storage unit that is in the terminal and that is located outside the chip, such as a read-only memory (ROM), another type of static storage device that can store static information and an instruction, or a random access memory (RAM).

The processor mentioned in any one of the foregoing items may be a general-purpose central processing unit (CPU), a microprocessor, an application-specific integrated circuit (ASIC), or one or more integrated circuits that are configured to control execution of a program in the wireless communication method in the first aspect.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected according to actual needs to achieve the objectives of the solutions of the embodiments. In addition, in the accompanying drawings of the apparatus embodiments provided by this application, connection relationships between modules indicate that the modules have communication connections with each other, which may be specifically implemented as one or more communications buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be of various forms, for example, in a form of an analog circuit, a digital circuit, a dedicated circuit, or the like. However, as for this application, software program implementation is a better implementation in most cases. Based on such an understanding, the technical solutions of this application essentially or the part contributing to the prior art may be implemented in a form of a software product. The software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a server, or a network device) to perform the methods described in the embodiments of this application.

All or some of the foregoing embodiments may be implemented by using software, hardware, firmware, or any combination thereof. When software is used to implement the embodiments, the embodiments may be implemented completely or partially in a form of a computer program product.

The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (Solid State Disk, SSD)), or the like.

What is claimed is:

1.-15. (canceled)

16. A terminal screen projection control method, comprising:
collecting, by a terminal, first voice data, wherein the terminal is connected to a display device;
obtaining, by the terminal, an operation command according to the first voice data, wherein the operation command is used for operating a target application; and
controlling, by the terminal based on the operation command, the display device to display an operation process of the target application.

17. The method according to claim 16, wherein the operation command comprises a first operation command and a second operation command that are obtained successively;
wherein controlling the display device to display an operation process of the target application comprises:
in response to obtaining the first operation command, controlling, by the terminal, first display content of the target application to be displayed on the display device, wherein the first display content is displayed when the target application program performs an operation corresponding to the first operation command; and
in response to obtaining the second operation command, controlling, by the terminal, the first display content of the target application program displayed on the display device to switch to second display content, wherein the second display content is displayed when the target application program performs an operation corresponding to the second operation command.

18. The method according to claim 17, wherein the operation command further comprises a third operation command used to instruct to open the target application, and the terminal obtains the third operation command before obtaining the first operation command; and
wherein controlling the display device to display an operation process of the target application further comprises:
in response to obtaining the third operation command, controlling, by the terminal, the display device to display a home page of the target application program.

19. The method according to claim 16, wherein content displayed on the terminal is different from content displayed on the display device.

20. The method according to claim 16, wherein controlling the display device to display an operation process of the target application comprises:
recognizing, by the terminal, an application program interface corresponding to the one or more operation commands;
controlling, by the terminal, the target application using the application program interface; and
displaying the operation process of the target application on the display device.

21. The method according to claim 20, wherein obtaining the operation command comprises:
performing, by the terminal, voice recognition processing on the first voice data; and
performing, by the terminal, semantic parsing on a result of the voice recognition processing to generate a semantic parsing result, wherein the semantic parsing result comprises the operation command, and
wherein recognizing the application program interface comprises: recognizing, by the terminal, the application program interface according to the semantic parsing result.

22. The method according to claim 20, wherein obtaining an operation command comprises:
performing, by the terminal, voice recognition processing on the first voice data;
sending, by the terminal, a result of the voice recognition processing to a cloud server, so that the cloud server performs semantic parsing on the result of the voice recognition processing; and
receiving, by the terminal, an analysis result fed back by the cloud server after semantic analysis, wherein the semantic parsing result comprises the operation command, and wherein
recognizing the application program interface comprises: recognizing, by the terminal, the application program interface according to the semantic parsing result.

23. The method according to claim 16, wherein controlling an operation process of displaying the target application on the display device further comprises:
obtaining, by the terminal, a feedback result of the target application, wherein the feedback result is used to indicate an execution result of the operation command; and
outputting, by the terminal, the feedback result.

24. The method according to claim 23, wherein outputting the feedback result comprises:
converting, by the terminal, the feedback result into second voice data, and playing the second voice data; or
displaying, by the terminal, the feedback result on the display device.

25. The method according to claim 16, wherein collecting first voice data comprises:
invoking, by the terminal, a voice assistant in a wake-up-word-free manner, so that the voice assistant performs voice collection on the first voice data.

26. A terminal, comprising a voice collector and a processor communicatively coupled to the voice collector, wherein
the voice collector is configured to collect first voice data, and wherein
the processor is configured to perform operations comprising:
obtaining an operation command according to the first voice data, wherein the operation command is used for operating a target application; and
controlling based on the operation command, the display device to display an operation process of the target application, wherein the terminal is connected to the display device.

27. The terminal according to claim 26, wherein the operation command comprises a first operation command and a second operation command that are obtained successively;
wherein controlling based on the operation command, the display device to display an operation process of the target application comprises:
in response to obtaining a first operation command, controlling first display content of the target application to be displayed on the display device, wherein the first display content is displayed when the target application program performs an operation corresponding to the first operation command; and
in response to obtaining the second operation command, controlling the first display content of the target application program displayed on the display device to switch to second display content, wherein the second display content is displayed when the target application program performs an operation corresponding to the second operation command.

28. The terminal according to claim 27, wherein the operation command further comprises a third operation command used to instruct to open the target application, and the processor obtains the third operation command before obtaining the first operation command; and,
wherein controlling based on the operation command, the display device to display an operation process of the target application comprises further comprises:
in response to obtaining the third operation command, controlling the display device to display a home page of the target application program.

29. The terminal according to claim 26, wherein content displayed on the terminal is different from content displayed on the display device.

30. The terminal according to claim 26, wherein controlling based on the operation command, the display device to display an operation process of the target application comprises:
recognizing an application program interface corresponding to the operation command;
controlling the target application program by using the application program interface; and
displaying the operation process of the target application program on the display device.

31. The terminal according to claim 30, wherein obtaining the one or more operation commands comprises:
performing voice recognition processing on the first voice data; and
performing semantic parsing on a result of the voice recognition processing, to generate a semantic parsing result, wherein the semantic parsing result comprises the operation command, and
wherein recognizing the application program interface comprises: recognizing the application program interface according to the semantic parsing result.

32. The terminal according to claim 30, wherein obtaining an operation command comprises:
performing voice recognition processing on the first voice data;
sending a result of the voice recognition processing to a cloud server, so that the cloud server performs semantic parsing on the result of the voice recognition processing; and
receiving an analysis result fed back by the cloud server after semantic analysis, wherein the semantic parsing result comprises the operation command, and wherein
recognizing the application program interface comprises: recognizing the application program interface according to the semantic parsing result.

33. The terminal according to claim 26, wherein controlling an operation process of displaying the target application on the display device, further comprises:
obtaining a feedback result of the target application, wherein the feedback result is used to indicate an execution result of the operation command; and
outputting the feedback result.

34. The terminal according to claim 26, wherein the processor is further configured to invoke a voice assistant in a wake-up-word-free manner, and wherein
the voice collector is configured to perform voice collection on the first voice data under control of the voice assistant.

35. A non-transitory machine-readable storage medium, comprising executable instructions, when executed by one or more processors, causes the one or more processors to perform operations of:
collecting, by a terminal, first voice data, wherein the terminal is connected to a display device;
obtaining, by the terminal, one or more operation commands according to the first voice data, wherein the one or more operation commands are used for operating a target application; and
controlling, by the terminal based on the one or more operation commands, the display device to display an operation process of the target application.
